(19) United States
(12) Patent Application Publication
(10) Pub. No.: US 2020/0298757 A1
(43) Pub. Date: Sep. 24, 2020

(54) STAGED TROUBLESHOOTING AND REPAIR OF VEHICLE TRAILER LIGHTING MALFUNCTIONS

(71) Applicant: TOYOTA MOTOR ENGINEERING & MANUFACTURING NORTH AMERICA, INC., Plano, TX (US)

(72) Inventors: Derek A. Thompson, Ypsilanti, MI (US); Darin P. Rosekrans, South Lyon, MI (US)

(73) Assignee: TOYOTA MOTOR ENGINEERING & MANUFACTURING NORTH AMERICA, INC.

(21) Appl. No.: 16/362,303

(22) Filed: Mar. 22, 2019

(51) Int. Cl. B60Q 11/00; G07C 5/08

(52) U.S. Cl. CPC B60Q 11/005; G07C 5/0808; B60Q 11/007; G07C 5/0833; G07C 5/0825

(57) ABSTRACT

Disclosed is a vehicle including an automotive trailer lighting diagnostic system, the system including: a trailer, one or more trailer lights disposed on the trailer, and one or more components of the vehicle or trailer that are associated with the one or more trailer lights. The vehicle also includes a user interface, and a control unit configured to: activate the trailer lights in a particular sequence, receive a signal identifying at least one malfunctioning trailer light, and identify a diagnostic procedure from a plurality of diagnostic procedures. The control unit is further configured to initiate the identified diagnostic procedure, execute the steps of the diagnostic procedure by soliciting information from a user via the user interface, issuing instructions to the user via the user interface, and executing branching logic steps. The control unit is further configured to initiate repair or replacement of the malfunctioning trailer light through user actions via the user interface, and recommend service options to the user if the diagnostic procedure is unable to return the at least one malfunctioning trailer light to working order.

### TECHNICAL FIELD

The subject matter described herein relates generally to enabling vehicles to guide users through step-by-step troubleshooting and repair of apparently malfunctioning vehicle trailer tail lights. This method has particular but not exclusive utility for consumer and commercial vehicles, including cars and trucks.

### BACKGROUND

Modern vehicles include complex electronic and electromechanical accessories, components, and subsystems, including power seats, seatbelts, sunroofs, sun shades, running boards, fold-out mirrors, mirror heaters, and others, leading to complex wiring assemblies and multiple opportunities for electronic issues (shorts, ground loops, firmware hang states, etc.). Even relatively simple systems such as trailer tail light assemblies may be routed through a complex system of wiring and logic circuits that make troubleshooting difficult for end users.

Troubleshooting a vehicle electrical component such as trailer tail lights (e.g., for failing to illuminate, or illuminating in the wrong sequence) can be a complex task with many unknowns, that could be the result of any of a number of possible causes. Further, tasks as seemingly simple as checking a fuse may be quite daunting, as many modern vehicles have three or more fuse boxes located throughout the vehicle (e.g., engine compartment, under the instrument panel, next to the driver seat, inside the instrument panel, behind the glove box, next to the battery, in the trunk, etc.). Then, after identifying the correct fuse and the correct fuse box location, a user often has to dismantle various vehicle components to access the fuse box and use a specialty tool to replace the fuse. Even after this is done, the problem may still persist. The user may then have to take the vehicle to a service station, despite an investment of substantial time and effort attempting to correct the problem at home.

For these and other reasons, current user's owner-accessible diagnostic and repair methods present numerous unaddressed challenges in the art. Accordingly, long-felt needs exist for diagnostic and repair systems that address the forgoing or other concerns.

The information included in this Background section of the specification is included for technical reference purposes only and is not to be regarded as subject matter by which the scope of the disclosure is to be bound.

### SUMMARY

Disclosed are apparatus, systems, and methods for enabling vehicles to instruct users to perform staged, step-by-step troubleshooting and repair of apparently malfunctioning trailer lighting components, the apparatus, systems, and methods henceforth referred to collectively as a “trailer lighting diagnostic system.” The trailer lighting diagnostic system may detect faults and recommend specific actions to the user or vehicle owner, in order to isolate (and in some instances, repair) the fault.

One general aspect includes a vehicle including an automotive trailer lighting diagnostic system, the system including: a trailer, one or more trailer lights disposed on the trailer, one or more components of the vehicle or trailer that are associated with the one or more trailer lights, a user interface, and a control unit configured to activate the one or more trailer lights in a particular sequence, receive a signal identifying at least one malfunctioning trailer light of the one or more trailer lights, automatically identify a diagnostic procedure for the at least one malfunctioning trailer light from a plurality of diagnostic procedures and initiate the identified diagnostic procedure, execute the steps of the diagnostic procedure by: soliciting information from a user via the user interface, issuing instructions to the user via the user interface, executing branching logic steps, and initiate repair or replacement of the at least one malfunctioning trailer light through user actions via the user interface; and recommend service options to the user if the diagnostic procedure is unable to return the at least one malfunctioning trailer light to working order.

A system of one or more control units can be configured to perform particular operations or actions by virtue of having software, firmware, hardware, diagnostic procedures, fault trees, or a combination of them installed on the system that in operation causes or cause the system to perform the actions. One or more diagnostic procedures can be configured to perform particular operations or actions by virtue of including instructions that, when executed by data processing apparatus, cause the apparatus to perform the actions. Other embodiments of this aspect include corresponding control units, apparatus, and diagnostic procedures recorded on one or more control-unit-accessible storage devices, each configured to perform the actions of the methods.

Implementations may include one or more of the following features. The vehicle where soliciting information from the user or issuing instructions to the user involves a voice interface. The vehicle where soliciting information from the user or issuing instructions to the user involves a visual interface. The vehicle where soliciting information from the user or issuing instructions to the user involves a dashboard head unit. The vehicle where soliciting information from the user or issuing instructions to the user involves a portable device. The vehicle where the portable device includes an augmented reality device and the instructions to the user include augmented reality instructions. The vehicle where the at least one malfunctioning trailer light includes a brake light. The vehicle where the at least one malfunctioning trailer light includes a turn signal indicator light. The vehicle where the at least one malfunctioning trailer light includes a tail light. The vehicle where the at least one malfunctioning trailer light includes a backup light. The vehicle where the instructions to the user include activating controls within the automotive trailer lighting diagnostic system. The vehicle where the instructions to the user include physical examination of the one or more components of the vehicle or trailer that are associated with the one or more trailer lights. The vehicle where the instructions to the user include physical replacement of the one or more components of the vehicle or trailer that are associated with the one or more trailer lights. Implementations of the described techniques may include hardware, a method or process, or control unit software on a control-unit-accessible medium.

One general aspect includes a method for returning malfunctioning automotive trailer lamps to working condition, the method including: activating one or more trailer lamps in a sequence, receiving a status of at least one malfunctioning trailer lamp of the one or more trailer lamps by receiving a signal from a user via a user interface, identifying a diagnostic procedure stored in a memory from a plurality of diagnostic procedures stored in the memory, executing branching logic steps of the identified diagnostic procedure from the memory for the at least one malfunctioning trailer lamp; soliciting information from the user about the at least one malfunctioning trailer lamp, issuing instructions to the user regarding the at least one malfunctioning trailer lamp and, if at an endpoint of the diagnostic procedure, the at least one malfunctioning trailer lamp continues to malfunction, recommending service options to the user. Other embodiments of this aspect include corresponding control units, systems, apparatus, and instructions recorded on one or more control-unit-accessible storage devices, each configured to perform the actions of the methods.

Implementations may include one or more of the following features. The method where soliciting information from or issuing instructions to the user involves a voice interface. The method where soliciting information from the user or issuing instructions to the user involves a visual interface. The method where soliciting information from the user or issuing instructions to the user involves a dashboard head unit or portable device. The method where the portable device includes an augmented reality device. The method where the at least one malfunctioning trailer lamp includes a brake lamp, a turn signal lamp, a tail lamp, or a backup lamp. Implementations of the described techniques may include hardware, a method or process, or control unit instructions on a control-unit-accessible medium.

One general aspect includes a vehicle trailer lighting diagnostic module including a user interface, and a processor configured to activate one or more trailer lights of a vehicle in a particular sequence, receive a signal indicative of a status of one or more malfunctioning trailer lights of the one or more trailer lights, automatically identify a diagnostic procedure for the one or more malfunctioning trailer lights from a plurality of diagnostic procedures, and initiate the identified diagnostic procedure. The processor is also configured to execute branched logic paths of the identified diagnostic procedure, solicit information from a user regarding the one or more malfunctioning trailer lights, issue instructions to the user regarding the one or more malfunctioning trailer lights, and recommend service options to the user if an endpoint of the identified diagnostic procedure indicates a continued malfunction status of at least one of the one or more malfunctioning trailer lights. Other embodiments of this aspect include corresponding control units, apparatus, and diagnostic procedures or fault trees recorded on one or more control-unit-accessible storage devices, each configured to perform the actions of the methods. The trailer lighting diagnostic system disclosed herein has particular, but not exclusive, utility for consumer and commercial vehicles, including cars and trucks.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the method, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is a diagrammatic illustration of a vehicle including a trailer lighting diagnostic system, in accordance with at least one embodiment of the present disclosure.

FIG. 2 is a block diagram including several components of the trailer lighting diagnostic system of FIG. 1, in accordance with at least one embodiment of the present disclosure.

FIG. 3 is a diagrammatic illustration of an example vehicle including trailer and trailer lighting, in accordance with at least one embodiment of the present disclosure.

FIG. 4 is a flow diagram showing exemplary process steps undertaken by a trailer lighting diagnostic system according to at least one embodiment of the present disclosure.

FIG. 5 is a diagrammatic illustration of an example user interrogation display according to at least one embodiment of the present disclosure.

FIG. 6 is a diagrammatic view of an example augmented reality display on a portable device in accordance with at least one embodiment of the present disclosure.

### DETAILED DESCRIPTION

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. It is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

Often, when diagnosing faults in automotive accessories, components, or subsystems, vehicle owners are unaware of the possible causes or the steps required to isolate them. The trailer lighting diagnostic system of the present disclosure may provide a simple, convenient, and cost-effective method to aid a user in troubleshooting problems that occur with vehicle trailer lights (e.g., brake lights, turn signals). In some embodiments, the trailer lighting diagnostic system begins troubleshooting the problem by asking a series of questions, starting with questions relating to the most likely or most easily identifiable cause down to the most complex issues that may require a service technician. In some embodiments, the trailer lighting diagnostic system provides instructions through a user interface such as an interactive voice interface, touchscreen, or both where instructions may be given through any combination of audio, visual (e.g., images, text, symbols), or video playback methods, including streaming from an onboard database, or through a wireless network or server connection, or cloud storage device.

In some exemplary embodiments, an application program interface (API) on a smartphone, onboard monitor, or other electronic device may be employed. The trailer lighting diagnostic system may provide a branched diagnostic procedure that walks a user through one or more steps to inspect for symptoms (to further diagnose the problem) or one or more steps to repair the problem. After each step, the system will ask the user to confirm whether the issue was resolved or whether a specific action has occurred (e.g., whether a lamp is illuminated). In an example, once positive or negative confirmation is given, the system will complete the troubleshooting or move to a next possible cause and remedy until the issue is resolved. This will help the user isolate the issue, and for each point of occurrence, if resolution criteria are not met, the system may provide locations for parts to be replaced, instructions on how to replace them, and the ability to check part inventory at nearby dealerships. Some issues may require service with sophisticated equipment by a professional technician, and in these cases, the trailer lighting diagnostic system may identify that such service is necessary and recommend it to the user.

The present disclosure aids substantially in automotive component fault correction, by improving the ability of vehicles to overcome certain malfunctions in an automated manner, without the need for professional service or complex actions undertaken by a vehicle owner. Implemented on a processor in communication with a sensor associated with the malfunctioning component, the trailer lighting diagnostic system disclosed herein may provide practical self-diagnosis and self-repair capabilities to motor vehicles. This streamlined and augmented diagnostic and repair capability transforms a non-functioning vehicle component into a functioning one, without the normally routine need for a user to read manuals, follow written procedures, put the vehicle into a “manufacturer mode”, or be familiar with manufacturer-specific and model-specific fault trees. This unconventional approach improves the functioning and uptime of the vehicle while reducing cost of ownership, by automatically restoring malfunctioning vehicle components to working condition.

The trailer lighting diagnostic system may comprise a subroutine that includes a user interface viewable on a display, and operated by control processes executed on a processor that may accept user inputs from a user interface such as a voice, gesture, or touchscreen interface, and that is in communication with one or more trailer lights. In that regard, the control processes perform certain specific operations in response to different conditions, including but not limited to sensor readings and user inputs. Certain structures, functions, and operations of the processor, display, sensors, and user input systems are known in the art, while others are recited herein to enable novel features or aspects of the present disclosure with particularity.

These descriptions are provided for exemplary purposes, and should not be considered to limit the scope of the trailer lighting diagnostic system. Certain features may be added, removed, or modified without departing from the spirit of the claimed subject matter.

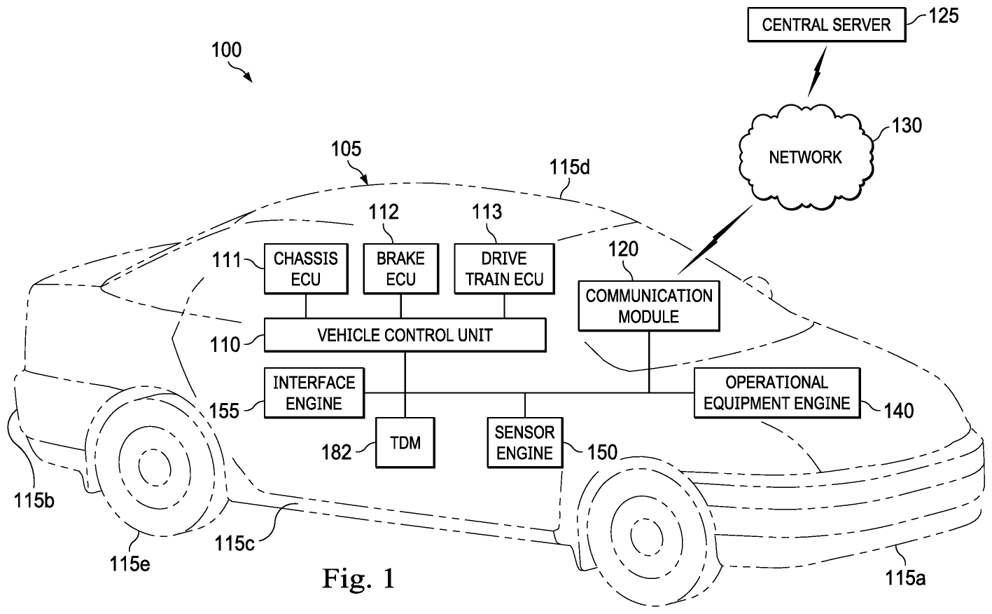

FIG. 1 is a diagrammatic illustration of a vehicle including a trailer lighting diagnostic system, in accordance with at least one embodiment of the present disclosure. In an example, the trailer lighting diagnostic system is referred to by the reference numeral 100 and includes a vehicle 105, such as an automobile, and a vehicle control unit 110 located on the vehicle 105. The vehicle 105 may include a front portion 115a (including a front bumper), a rear portion 115b (including a rear bumper), a right side portion 115c (including a right front quarter panel, a right front door, a right rear door, and a right rear quarter panel), a left side portion 115d (including a left front quarter panel, a left front door, a left rear door, and a left rear quarter panel), and wheels 115e. A communication module 120 is operably coupled to, and adapted to be in communication with, the vehicle control unit 110. The communication module 120 is adapted to communicate wirelessly with a central server 125 via a network 130 (e.g., a 3G network, a 4G network, a 5G network, a Wi-Fi network, or the like). The central server 125 may provide information and services including but not limited to include location, mapping, scheduling, SMS, and email.

An operational equipment engine 140 is operably coupled to, and adapted to be in communication with, the vehicle control unit 110. A sensor engine 150 is operably coupled to, and adapted to be in communication with, the vehicle control unit 110. The sensor engine 150 is adapted to monitor various components of, for example, the operational equipment engine 140, as will be described in further detail below. An interface engine 155 is operably coupled to, and adapted to be in communication with, the vehicle control unit 110. In addition to, or instead of, being operably coupled to, and adapted to be in communication with, the vehicle control unit 110, the communication module 120, the operational equipment engine 140, the sensor engine 150, and/or the interface engine 155 may be operably coupled to, and adapted to be in communication with, another of the components via wired or wireless communication (e.g., via an in-vehicle network). In some examples, the vehicle control unit 110 is adapted to communicate with the communication module 120, the operational equipment engine 140, the sensor engine 150, and the interface engine 155 to control at least partially the interaction of data with and between the various components of the trailer lighting diagnostic system 100.

The term “engine” is meant herein to refer to an agent, instrument, or combination of either, or both, agents and instruments that may be associated to serve a purpose or accomplish a task—agents and instruments may include sensors, actuators, switches, relays, power plants, system wiring, computers, components of computers, programmable logic devices, microprocessors, software, software routines, software modules, communication equipment, networks, network services, and/or other elements and their equivalents that contribute to the purpose or task to be accomplished by the engine. Accordingly, some of the engines may be software modules or routines, while others of the engines may be hardware and/or equipment elements in communication with any or all of the vehicle control unit 110, the communication module 120, the network 130, or a central server 125.

In this example, the vehicle 105 also includes a chassis electronic control unit (ECU) 111 which controls elements of the vehicle's suspension system, a brake ECU 112 which controls the braking system or elements thereof, and a drive train ECU 113 (variously known as an engine ECU, power plant ECU, or motor ECU) that controls elements of the motor and drivetrain. A reader of ordinary skill in the art will understand that other components or arrangements of components may be found in a vehicle 105, and that the same general principles apply to electric vehicles, internal combustion vehicles, and hybrid vehicles.

In some embodiments, the trailer lighting diagnostic system 100 further includes a Trailer Diagnostic Module (TDM) 182.

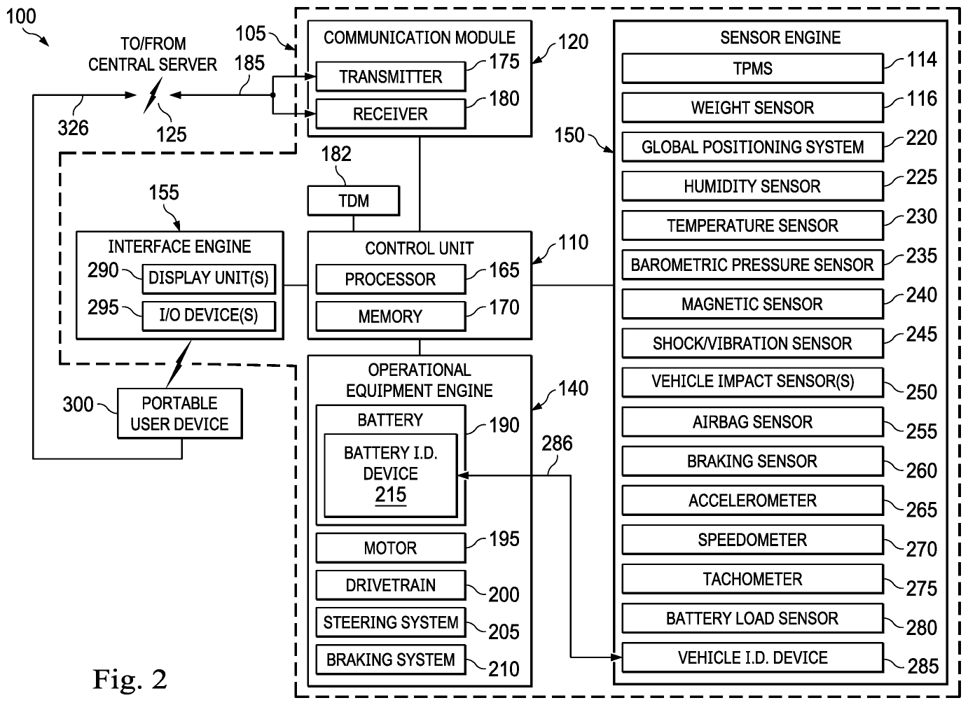

FIG. 2 is a block diagram including several components of the trailer lighting diagnostic system of FIG. 1, in accordance with at least one embodiment of the present disclosure. It is worth noting that the components of the vehicle 105 may be located either permanently or temporarily as a part of the vehicle 105. The vehicle control unit (VCU) 110 includes a processor 165 and a memory 170. In some examples, the communication module 120, which is operably coupled to, and adapted to be in communication with, the vehicle control unit 110, includes a transmitter 175 and a receiver 180. In some examples, one or the other of the transmitter 175 and the receiver 180 may be omitted according to the particular application for which the communication module 120 is to be used. In other examples, the transmitter 175 and receiver 180 are combined into a single transceiver that performs both transmitting and receiving functions.

In some examples, the operational equipment engine 140, which is operably coupled to, and adapted to be in communication with, the vehicle control unit 110, includes a plurality of devices configured to facilitate driving of the vehicle 105. In this regard, the operational equipment engine 140 may be designed to exchange communication with the vehicle control unit 110, so as to not only receive instructions, but to provide information on the operation of the operational equipment engine 140. For example, the operational equipment engine 140 may include a vehicle battery 190, a motor 195, a drivetrain 200, a steering system 205, and a braking system 210. In an example, the vehicle battery 190 provides electrical power to the motor 195 to drive the wheels 115e of the vehicle 105 via the drivetrain 200. In some examples, in addition to providing power to the motor 195 to drive the wheels 115e of the vehicle 105 via the drivetrain 200, the vehicle battery 190 provides electrical power to another component of the operational equipment engine 140, the vehicle control unit 110, the communication module 120, the sensor engine 150, the interface engine 155, or any combination thereof. In some examples, the vehicle battery 190 includes a battery identification device 215. The battery identification device 215 is adapted to communicate with one or more components of the sensor engine 150, and stores data identifying the vehicle battery 190 such as, for example, manufacturing information (e.g., production date, production facility, etc.), battery characteristic(s) information, battery identification number information, electric vehicle compatibility information, or the like.

In some examples, the sensor engine 150, which is operably coupled to, and adapted to be in communication with, the vehicle control unit 110, includes devices such as sensors, meters, detectors, or other devices configured to measure or sense a parameter related to a driving operation or other operation of the vehicle 105. For example, the sensor engine 150 may include a global positioning system 220, a humidity sensor 225, a temperature sensor 230, a barometric pressure sensor 235, a magnetic sensor 240, a shock/vibration sensor 245, a vehicle impact sensor 250, an airbag sensor 255, a braking sensor 260, an accelerometer 265, a speedometer 270, a tachometer 275, a battery load sensor 280, a vehicle identification device 285, a tire pressure monitoring system (TPMS) 114, a weight sensor 116, or any combination thereof. The sensors or other detection devices may be configured to sense or detect activity, conditions, and circumstances in an area to which the device has access, e.g., ambient conditions or conditions within a battery compartment. Sub-components of the sensor engine 150 may be deployed at any operational area where information on the driving of the vehicle 105 may occur. Readings from the sensor engine 150 are fed back to the vehicle control unit 110. Stored and reported performance data may include the sensed data, or may be derived, calculated, or inferred from sensed data. The vehicle control unit 110 may send signals to the sensor engine 150 to adjust the calibration or operating parameters of the sensor engine 150 in accordance with a control program in the vehicle control unit 110. The vehicle control unit 110 is adapted to receive and process performance data from the sensor engine 150 or from other suitable source(s), and to monitor, store (e.g., in the memory 170), and/or otherwise process (e.g., using the processor 165) the received performance data.

The braking sensor 260 is adapted to monitor usage of the vehicle 105's braking system 210 (e.g., an antilock braking system 210) and to communicate the braking information to the vehicle control unit 110. The accelerometer 265 is adapted to monitor acceleration of the vehicle 105 and to communicate the acceleration information to the vehicle control unit 110. The accelerometer 265 may be, for example, a two-axis accelerometer 265 or a three-axis accelerometer 265. In some examples, the accelerometer 265 is associated with an airbag of the vehicle 105 to trigger deployment of the airbag. The speedometer 270 is adapted to monitor speed of the vehicle 105 and to communicate the speed information to the vehicle control unit 110. In some examples, the speedometer 270 is associated with a display unit of the vehicle 105 such as, for example, a display unit of the interface engine 155, to provide a visual indication of vehicle speed to a driver of the vehicle 105. The tachometer 275 is adapted to monitor the working speed (e.g., in revolutions-per-minute) of the vehicle 105's motor 195 and to communicate the angular velocity information to the vehicle control unit 110. In some examples, the tachometer 275 is associated with a display unit of the vehicle 105 such as, for example, a display unit of the interface engine 155, to provide a visual indication of the motor 195's working speed to the driver of the vehicle 105. The battery load sensor 280 is adapted to monitor charging, discharging, and/or overcharging of the vehicle battery 190 and to communicate the charging, discharging, and/or overcharging information to the vehicle control unit 110.

In some examples, the vehicle identification device 285 stores data identifying the vehicle 105 such as, for example, manufacturing information (e.g., make, model, production date, production facility, etc.), vehicle characteristic(s) information, vehicle identification number (“VIN”) information, battery compatibility information, or the like. The vehicle identification device 285 is adapted to communicate with the battery identification device 215 (or vice versa), as indicated by arrow 286. In some examples, the vehicle identification device 285 and the battery identification device 215 may each communicate with the vehicle control unit 110.

In some examples, the interface engine 155, which is operably coupled to, and adapted to be in communication with, the vehicle control unit 110, includes at least one input and output device or system that enables a user to interact with the vehicle control unit 110 and the functions that the vehicle control unit 110 provides. For example, the interface engine 155 may include a display unit 290 and an input/output (“I/O”) device 295. The display unit 290 may be, include, or be part of multiple display units. In some examples, the display unit 290 may include one, or any combination, of a central display unit associated with a dash of the vehicle 105, an instrument cluster display unit associated with an instrument cluster of the vehicle 105, and/or a heads-up display unit associated with the dash and a windshield of the vehicle 105; accordingly, as used herein the reference numeral 290 may refer to one, or any combination, of the display units. The I/O device 295 may be, include, or be part of a communication port (e.g., a USB port), a Bluetooth communication interface, a tough-screen display unit, soft keys associated with a dash, a steering wheel, or another component of the vehicle 105, and/or similar components. Other examples of sub-components that may be part of the interface engine 155 include, but are not limited to, audible alarms, visual alerts, telecommunications equipment, and computer-related components, peripherals, and systems.

In some examples, a portable user device 300 operated by an occupant of the vehicle 105 may be coupled to, and adapted to be in communication with, the interface engine 155. For example, the portable user device 300 may be coupled to, and adapted to be in communication with, the interface engine 155 via the I/O device 295 (e.g., the USB port and/or the Bluetooth communication interface). In an example, the portable user device 300 is a handheld or otherwise portable device which is carried onto the vehicle 105 by a user who is a driver or a passenger on the vehicle 105. In addition, or instead, the portable user device 300 may be removably connectable to the vehicle 105, such as by temporarily attaching the portable user device 300 to the dash, a center console, a seatback, or another surface in the vehicle 105. In another example, the portable user device 300 may be permanently installed in the vehicle 105. In some examples, the portable user device 300 is, includes, or is part of one or more computing devices such as personal computers, personal digital assistants, cellular devices, mobile telephones, wireless devices, handheld devices, laptops, audio devices, tablet computers, game consoles, cameras, smartwatches, and/or any other suitable devices. In several examples, the portable user device 300 is a smartphone such as, for example, an iPhone® by Apple Incorporated.

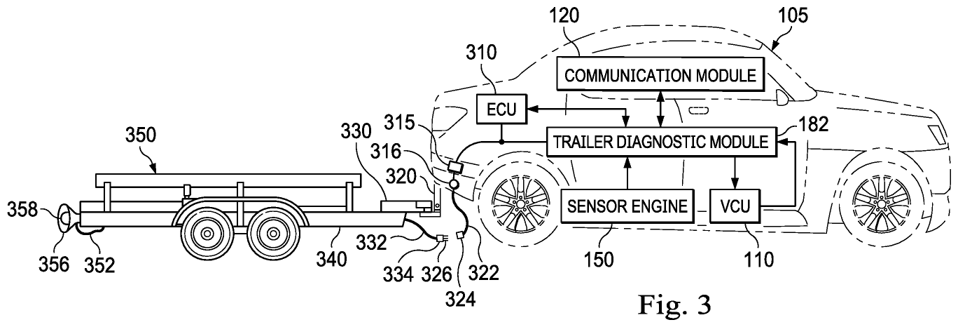

In some embodiments, the trailer lighting diagnostic system 100 further includes a trailer diagnostic module (TDM) 182. The TDM 182 may be a software module, a hardware module, a firmware module, or any combination thereof, and may be a standalone module or may be integrated into other vehicle components such as the VCU 110 or Sensor Engine 150. In these embodiments, the TDM is in communication with vehicle trailer lighting (see FIG. 3), either by receiving data from sensors associated with trailer lighting (e.g., fuse or lamp filament continuity sensors), by receiving data from status variables associated with each component (e.g., status bits, status bytes, status words, or error codes), or by exchanging other data with an ECU or VCU associated with the trailer lighting.

A reader of ordinary skill in the art will understand that other components or arrangements of components may be found in a vehicle 105, and that the same general principles apply to electric vehicles, internal combustion vehicles, and hybrid vehicles.

FIG. 3 is a diagrammatic illustration of an example vehicle 105 including trailer 350 and trailer lighting 356, in accordance with at least one embodiment of the present disclosure.

In the example shown in the figure, the vehicle 105 includes a towing diagnostic module or trailer diagnostic module 182, trailer hitch 320, vehicle-side trailer wiring harness 322, and vehicle-side trailer wiring connector 324. The trailer includes a trailer-side wiring connector 334, trailer-side wiring harness 332, hitch tongue 330, trailer bed 340, lamp wiring harness 352, lamp assembly 356, and lamp bulb 358. In an example, the vehicle side wiring harness is in communication with at least one of the VCU 110, sensor engine 150, trailer diagnostic module (TDM) 182, and connects to the trailer-side wiring harness 332 through the vehicle-side connector 324 and trailer-side connector 334. In an example, the trailer wiring harness 332 is mated to the lamp wiring harness 352 underneath the trailer bed 340, although other arrangements are possible. It is noted that a typical trailer will have at least two lamp assemblies 356: one for the left tail light, turn signal, brake light, and backup light, and one for the right tail light, turn signal, and brake light, and backup light. Each lamp assembly 356 may have its own lamp wiring harness 352, or a single lamp wiring harness 352 may control multiple lamp assemblies.

In some examples, the tail light, turn signal, and brake light are three different bulbs 358 which illuminate according to different stimuli. In other examples, two or more of the tail light, blinker light, and brake light functions may be displayed through different brightness levels of a single bulb 358. Different brightness levels may be achieved through any combination of voltage changes, current changes, pulse width modulation, or other related methods. Illumination of the bulbs 358 may be controlled directly through wiring (e.g., activated by a brake pedal, blinker switch, or headlight switch), or may be controlled through software or firmware in an ECU 310 or VCU 110.

In some instances, failures in trailer lighting may be mechanical in nature (e.g., a broken bulb 358 or lamp assembly 356), or electronic (e.g., a shorted ECU 310), or electrical (e.g., a blown fuse 316, or a disconnected wire or misconnected wire in a wiring harness 322, 332, or 352), in which case, physical replacement of the failed components may be the only way to restore the lighting to an operational state. In other instances, failure of the component may involve software or firmware in a safe mode, maintenance mode, or hang state. Failures may also involve failure of a hardware-based or software-based sensor 315 (e.g., a continuity sensor). Resetting the sensor 315, ECU 310, or VCU 110 may clear this error condition. Failures may also involve a fuse 316 that has blown, such that replacing the fuse 316 may correct the malfunction.

In some embodiments, the trailer lighting diagnostic system receives an input from the user via the user interface (e.g. via voice, virtual agent, or touch input operating for example on the interface engine 155 or portable device 300), which identifies a problem. If more information is required, the system may ask questions of the user or ask the user to perform specific tasks (e.g., actuating a switch, or verifying the position, movement, or other state of a vehicle component) until the provided information describes or isolates the problem sufficiently that the system has identified a probable root cause and probable corrective action, and then verified that the corrective action has succeeded. In some instances, if the system is not able to resolve the problem, it may help further isolate a root cause of the problem and thus narrow the list of possible remedies. In some embodiments, the trailer lighting diagnostic system asks the user to confirm whether a trailer lamp is functioning properly. If not, the system will continue asking questions or recommending actions relating to the diagnosis. In other embodiments, the system automatically detects whether the component is working (e.g., by reading a continuity sensor).

The process continues until the problem is resolved. In instances where the root cause of a problem cannot be completely resolved by the user, the trailer lighting diagnostic system may recommend service options to the user for having the vehicle professionally serviced.

The trailer lighting diagnostic system of the present disclosure may provide a simple, convenient, and cost-effective method to aid in the resolution of problems that occur when trailer lights cease to function, or function incorrectly. In some embodiments, the trailer lighting diagnostic system begins troubleshooting the problem by asking a series of questions. This may start with questions directly relating to the onset of the problem. In other instances, the system begins troubleshooting by reading sensor values internal to the vehicle. If the answers suggest that a system reset or re-calibration will be helpful, either in resolving the issue or in further isolating a fault, the trailer lighting diagnostic system may recommend the steps required to reset or re-calibrate one or more components of the vehicle.

In some instances, the trailer lighting diagnostic system may guide the user through calibration or reset of a sensor (e.g., a continuity sensor) that is part of a malfunctioning subsystem. In other instances, the trailer lighting diagnostic system may calibrate or reset an electronic control unit (ECU) that is part of or local to the malfunctioning component or subsystem. In still other instances, the trailer lighting diagnostic system may reset the entire vehicle (e.g., by resetting a Vehicle Control Unit or VCU 110).

In instances where user interaction through a user interface is employed, the user may provide problem descriptions and answer questions through voice interaction, touchscreen, or any combination of audio, visual, gesture, selectable image, or virtual agent interaction. In some embodiments, diagnostic procedures are selected from a plurality of diagnostic procedures stored in an onboard database, or in a remote database accessed through a wireless network, server connection, or cloud storage device.

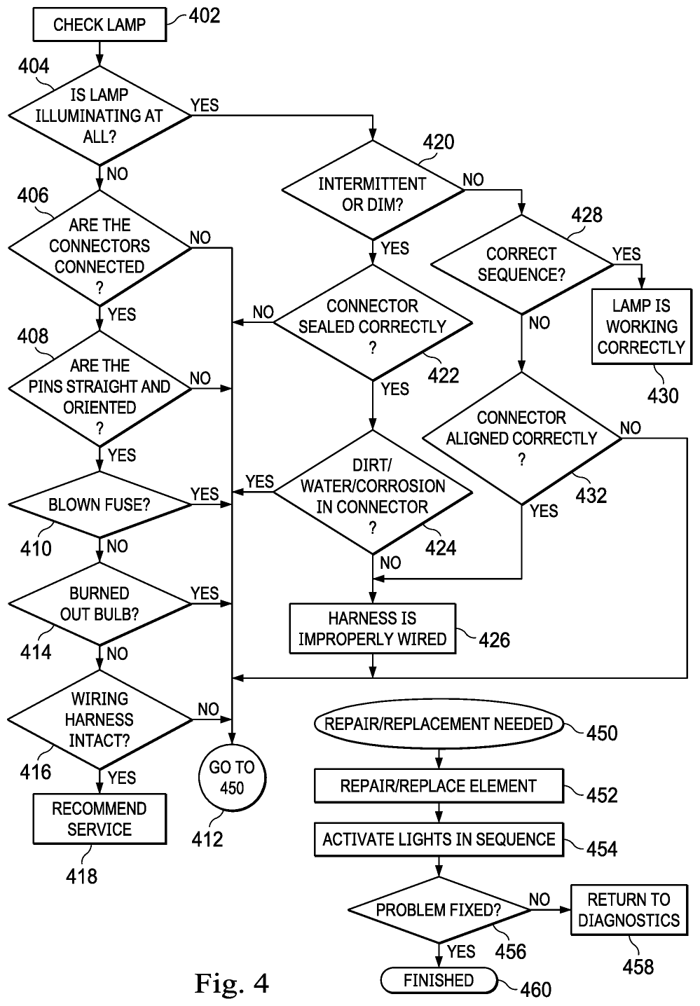

FIG. 4 is a flow diagram showing exemplary process steps undertaken by the trailer lighting diagnostic system 100 according to at least one embodiment of the present disclosure. The diagnostic system or the method carried out by the diagnostic system employs branching logic steps to determine performance parameters related to a malfunctioning or apparently malfunctioning component (e.g., a trailer brake light) by interacting with the user via the user interface (e.g., the interface engine 155 or portable device 300), in order to isolate, diagnose, and if possible guide user actions (e.g., activating controls, or physical examination or replacement of subcomponents), to repair the root cause of the component malfunction (e.g., a blown fuse or an ECU in a safe mode or hang state). Some steps involve branching logic decisions made internal to the system 100. Other steps require the user to visually observe a given lamp and answer questions about its behavior. Still other steps require the user to perform physical examination of vehicle or trailer subcomponents such as fuses 316, connectors (e.g., connectors 324 and 334), bulbs 358, and wiring harnesses (e.g., harnesses 322, 332, and 352), as detailed below. Still other steps require physical replacement of the inspected components.

In an example, the method begins with step 402, in which a lamp or bulb 358 is checked to see whether it is illuminating. The check at 402 may be performed either visually by a user or else autonomously by the trailer diagnostic module 182. The method performed by the diagnostic system 100 then proceeds to step 404, where either the trailer diagnostic module 182 determines whether the lamp or bulb 358 is illuminating at all, (e.g., by checking a continuity sensor), or the user interface (e.g., interface engine 155 or portable device 300) instructs the user to make this determination by visual inspection. When the user performs a visual inspection, the user may enter a response, such as yes (illuminating), or no (not illuminating) at the user interface. When automatically checked, the trailer diagnostic module 182 receives the response from the sensing component (e.g., continuity sensor). For clarity, these inputs (from the user or automatically from components of the diagnostic system) are not always reiterated through the example process described with reference to FIG. 4, yet they may be present whenever feedback is required. It is worth noting that the trailer diagnostic module 182 may perform the steps described via the user interface. Accordingly, user interface instructions may be based on processing of information and execution of the processes at the trailer diagnostic module 182.

If the answer at 404 is no, the lamp or bulb 358 is not illuminating, execution branches to step 406, where the user interface (under control of the trailer diagnostic module 182) instructs the user to determine whether the connectors (e.g., connectors 324 and 334) are connected. If the answer is input or automatically detected as no at 406, execution branches to step 412, which is a jump to step 450, described below. If the answer is input or automatically detected as yes at 406 (i.e., the connectors are indeed connected), then execution branches to step 408 where the user interface instructs the user to determine whether the connector pins (e.g., pins 326) are straight, and correctly oriented within the connection. If the answer is no at 408 (i.e., the pins are not straight or not correctly oriented), execution again branches to step 412 based on the answers received at the trailer diagnostic module 182 (via user input or sensor input).

If the answer is input or automatically detected as yes at 408 (i.e., the pins are straight and correctly oriented), then execution branches to step 410, where either the diagnostic module 182 determines whether there is a blown fuse (e.g., fuse 316) associated with that particular lamp or bulb, or the user interface (e.g., interface engine 155 or portable device 300) instructs the user to make the same determination. In some embodiments this step may be executed by, for example, instructing the user to remove and inspect a particular fuse at a particular location within the vehicle, and compare the fuse against representative images of an intact and a blown fuse. In other embodiments, the state of the fuse may be determined automatically, by, for example, checking the state of an electrical continuity sensor monitoring the fuse. If the answer at 410 is input or automatically detected as no (i.e., there is no blown fuse), then execution branches to step 414, where the trailer diagnostic module 182 uses the user interface to instruct the user to determine whether there is a burned-out bulb 358. The filament of an incandescent light bulb may be inspected in a manner similar to a fuse, as described above. An LED bulb can be tested in a bulb tester, or by connecting it to an appropriate DC power source and ground either within the vehicle or external to the vehicle Like fuses, bulbs may also be tested autonomously by the trailer diagnostic module 182 via a continuity sensor. If the answer at 414 is yes (i.e., the bulb 358 is burned out), execution branches to step 412, which is a jump to step 450, described below.

If the answer at 414 is no (i.e., the bulb is not burned out), then execution branches to step 416, where the user interface (e.g., interface engine 155 or portable device 300) instructs the user to determine (by inspection or other methods) whether a wiring harness (e.g., wiring harness 322, 332, or 352) is intact. In some embodiments, this determination may be made autonomously by the trailer diagnostic module 182 through continuity testing. If the answer at 416 is no (i.e., the harness is not intact), execution branches to step 412, which is a jump to step 450. If the answer at 416 is yes (i.e., the wiring harness is intact), then the problem may be suspected to be subtle or complex or inaccessible enough to require professional servicing of the vehicle. Execution therefore proceeds to endpoint step 418, where professional servicing is recommended to the user via the user interface (e.g., the interface engine 155 or portable device 300).

If the answer at step 404 is yes, the lamp or bulb 358 is illuminating, then execution branches to step 420, where the user interface instructs the user to determine (e.g., by visual inspection) whether the illumination of the bulb 358 is intermittent or dim. In some embodiments, this determination can instead be made autonomously by the TDU 182 using a continuity sensor. If the answer at 420 is yes (i.e., the illumination of the bulb is intermittent or dim), execution branches to step 422. In step 422, the user interface instructs the user to determine whether the connectors (e.g., connectors 424 and 434) are seated correctly. This may be done, for example, by asking the user (via the user interface) to disconnect and reconnect the connectors (e.g., connectors 324 and 334) several times. In some embodiments, a pictorial or video demonstration is provided to the user via the user interface (e.g., the interface engine 155 or portable device 300). If the answer at 422 is no (i.e., the connectors are not seated correctly), then execution branches to step 412, which is a jump to step 450. If the answer at 422 is yes, (i.e., the connectors are seated correctly), then execution branches to step 424, wherein the user interface instructs the user to determine (e.g., by visual inspection) whether there is dirt, water, debris, or corrosion in any of the connectors (e.g., connectors 324 and 334). If the answer at 424 is yes (i.e., debris is present), then execution branches to step 412. If the answer at 424 is no (i.e., debris is not present), then execution branches to step 426, where it is noted to the user via the user interface that one or more wiring harnesses are wired incorrectly. Execution then proceeds to step 412, which is a jump to step 450.

If the answer to step 420 is no (i.e., the illumination of the lamp or bulb 358 is not intermittent or dim), then execution branches to step 428, where the user interface (e.g., interface engine 155 or portable device 300) instructs the user to determine whether the lamp is operating in the correct sequence. For example, if the lamp is a right turn signal indicator, is it flashing when the right turn signal is activated? If the answer at 428 is yes (i.e., the lamp or bulb 358 is operating in the correct sequence), then execution branches to endpoint step 430, where the user is informed that the lamp or bulb 358 is working correctly. If the at 428 answer is no (i.e., the lamp or bulb 358 is not illuminating in the correct sequence), then execution branches to step 432, where the user interface instructs the user to determine whether the connectors (e.g., connectors 324 and 334) are aligned correctly. Some connectors have tabs, detents, or other features making it difficult for a user to connect them in the wrong orientation, but some connectors do not have these features, and some users may inadvertently or deliberately modify a connector such that an improperly aligned connection becomes more likely. Therefore, a user might be asked (via the user interface) to flip a connector over and see whether it fits, or to perform other related actions. If the answer at 432 is no (i.e., the connector is not aligned correctly), then execution branches to step 412, which is a jump to step 450. If the answer at 432 is yes (i.e., the connector is aligned correctly), then execution jumps to step 426, described above.

In step 450, the user is informed (via the user interface) that repair or replacement is needed for the subcomponent most recently interacted with. For example, if step 450 is reached from step 426, then repair or replacement of a wiring harness is needed. If step 450 is reached from step 414, then a bulb needs to be repaired or replaced. Execution then proceeds to step 452, where the user is given instructions (via the user interface) for the repair or replacement of that particular subcomponent. In some instances (e.g., changing a bulb), these instructions may be brief and straightforward. In other instances (e.g., repair of a wiring harness), step 452 may be complex an may involve multiple substeps that are specific to that particular subcomponent, problem, vehicle type, or model year. Such substeps may for example be executed as a sub-process from within the system 100. Once step 452 is complete, this means the repair or replacement of the appropriate subcomponent is believed to be complete. Execution then proceeds to step 454, wherein the trailer diagnostic unit 182 activates all of the trailer lamps in a particular sequence. The system 100 then proceeds to step 456, where the user is asked (via the user interface) whether the originally identified problem has been fixed, i.e., whether the lamp or bulb 358 in question now illuminates properly at the correct time in the sequence. If the answer at 456 is yes (i.e., the problem is fixed), the execution proceeds to endpoint step 460, where the diagnostic and repair procedure is declared to be finished. If the answer at 456 is no (i.e., the problem is not fixed because the lamp or bulb 358 is not illuminating correctly, or not illuminating at the correct time in the sequence), then execution proceed to step 458, which is a return to step 402 to re-start the diagnostic process.

These steps describe a particular diagnostic procedure of a particular embodiment of the trailer lighting diagnostic system 100 of the present disclosure. A reader of ordinary skill in the art will understand that the system 100 may employ diagnostic procedures comprising additional steps not described above, or may omit one or more of the described steps, or may perform one or more steps in a different sequence than described above, while remaining within the spirit, function, and advantages of the present disclosure. In particular, delay and trigger steps may be incorporated such that, for example, if an ECU 310 or VCU 110 is reset or restarted, the system 100 allows a certain interval to pass such that the ECU 310 or VCU 110 may enter a steady state before the system 100 proceeds to the next step. It is noted that some embodiments may include advantageous arrangements wherein user action is solicited only when autonomous interventions for a given problem have been attempted and have not been successful.

It is further noted that in some embodiments the system may include interfaces to mapping and scheduling functions external to the vehicle, such that when the system advises a user to have the vehicle professionally serviced, the system may be capable of identifying an appropriate service station (either autonomously or guided by user inputs), scheduling a service appointment that fits within the schedules of both the user and the service station, sending a detailed writeup of the problem to the service station (e.g., identity of the nonworking component and all steps taken to isolate, diagnose, or repair it.), and sending an automated calendar invitation to the user. Such embodiments are fully contemplated.

It is further noted that in some embodiments the trailer lighting diagnostic system 100 issues service instructions to the user through an augmented reality (AR) device providing AR instructions, wherein for example the locations of vehicle subcomponents (e.g., motors and relays), or the proper method for operating vehicle components (e.g., switches), or the proper methods for removing and replacing vehicle subcomponents (e.g., fuses) may be shown as virtual animation overlaid on top of live video. This may be done for example through the screen of a portable device 300 such as a smartphone, tablet, or AR-capable headset.

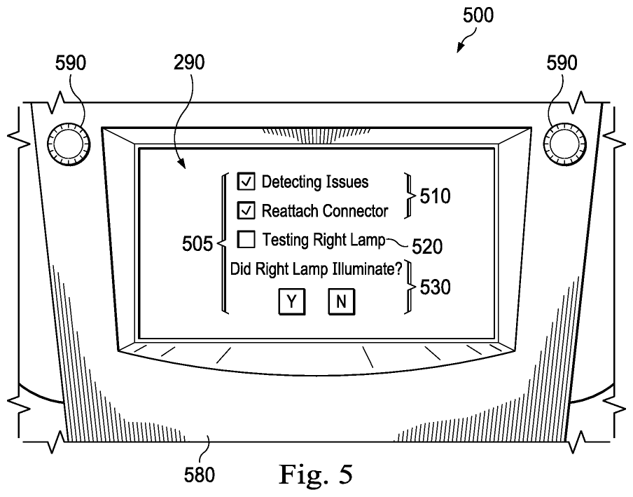

FIG. 5 is a diagrammatic illustration of an example user interrogation display or Human Machine Interface (HMI) 500 according to at least one embodiment of the present disclosure. The HMI 500 may be interactive, and may be facilitated for example through the dashboard Head Unit (HU) 580 or through a connected smartphone using an application program interface (API). In the example shown in the figure, the HMI 500 includes a text-based user interface 505 on the display unit 290 of the head unit 580. Also visible are control knobs 590. In some embodiments, the HMI 500 is part of, is the same element as, or is in communication with the interface engine 155 or portable device 300.

In the example shown in the figure, the text-based user interface 505 includes a report of completed steps 510 that the trailer lighting diagnostic system has executed, and uncompleted steps 520 that the trailer lighting diagnostic system has not yet executed or is currently executing. In some embodiments, such reports of completed and uncompleted steps enable the trailer lighting diagnostic system to inform the user about the status of the trailer lighting diagnostic system during a fault correction procedure. The text-based interface 505 also includes a user query 530 that poses a question to the user and allows the user to respond. In some embodiments, such user queries enable the trailer lighting diagnostic system to acquire information from the user that may not be available from sensors internal to the vehicle. In some embodiments, such user queries 530 are limited to yes-or-no questions such as “Did the right lamp illuminate?”. In other embodiments, user queries 530 may solicit numerical information from the user such as the flicker rate of a blinker bulb or turn signal indicator bulb 358. In still other embodiments, user queries may solicit more complex information to be interpreted by a virtual agent.

A person of ordinary skill in the art will appreciate that a variety of different user interfaces may be employed to provide information to the user, to request information from the user, and to receive information from the user (e.g., under the control of the interface engine 155 or the portable device 300). It is also noted that in many examples no user interaction may be required in order to detect and resolve a problem with a vehicle accessory, component, or subsystem. In some embodiments, the trailer lighting diagnostic system may provide a seamless interaction between the user and the vehicle through the HU 580 or connected device 300 wherein the required user action is conveniently limited to describing the problem and verifying that the problem has been resolved.

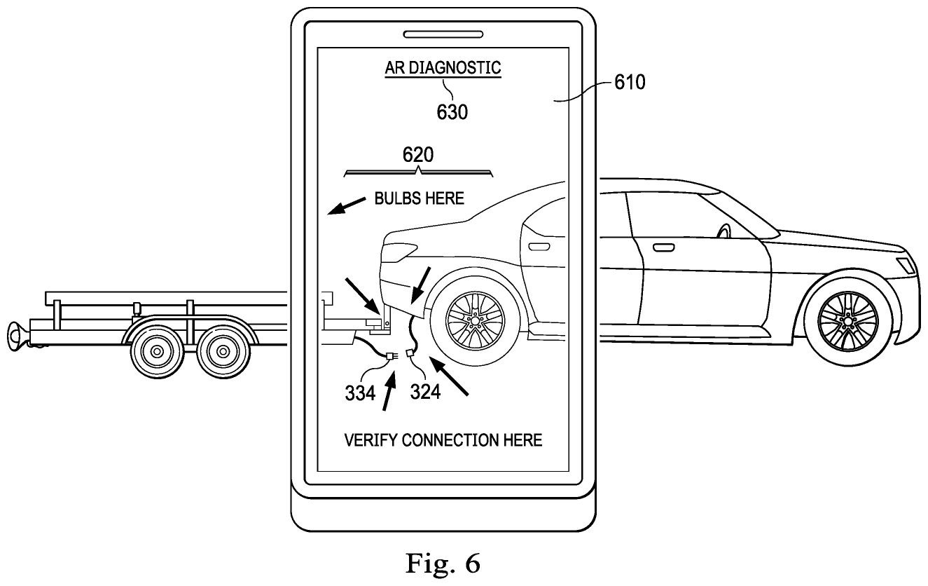

FIG. 6 is a diagrammatic view of an example augmented reality (AR) display 610 on a portable device 300 such as a smartphone or tablet device. When the vehicle 105 is viewed through the augmented reality display 610, certain features or subcomponents (e.g., connectors 324 and 334) related to a selected diagnostic procedure are highlighted with animated overlays 620 visible only on the display 610. The animated overlays 620 may show the positions of the subcomponents, in such a way that when the portable device 300 is moved or reoriented, the animated overlays 620 appear to hold a fixed position in real 3D space. The AR display 610 may also include fixed overlays 630 that appear to hold a constant or nearly constant position on the portable device 300, regardless of the position or orientation of the portable device 300.

Both the animated overlays 620 and fixed overlays 630 may provide graphics, symbols, text, icons, flashing or scrolling indicators, including visual, textual, auditory, or graphical instructions on how to find subcomponents (e.g, a bulb 358), or how to interact with subcomponents (e.g., 324 and 334).

A number of variations are possible on the examples and embodiments described above. For example, the display 290 could be replaced or supplemented with audible warnings, messages, flashing lights or indicators, data, and recommendations, or with haptic feedback (e.g., vibration of the portable device 300). The technology described herein may be implemented on manually controlled vehicles, driver-assist vehicles, or fully autonomous vehicles. The technology described herein may be implemented in diverse combinations of hardware, software, and firmware, depending on the implementation or as necessitated by the structures and modules already present in existing vehicles.

Accordingly, the logical operations making up the embodiments of the technology described herein may be referred to variously as operations, steps, objects, elements, components, or modules. Furthermore, it should be understood that these may be arranged in any order, unless explicitly claimed otherwise or a specific order is inherently necessitated by the claim language or by the nature of the component or step. In some instances, the words “light”, “lamp”, and “bulb” may be used interchangeably.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the trailer lighting diagnostic system. Connection references, e.g., attached, coupled, connected, and joined are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” Unless otherwise noted in the claims, stated values shall be interpreted as illustrative only and shall not be taken to be limiting.

The above specification, examples and data provide a complete description of the structure and use of exemplary embodiments of the trailer lighting diagnostic system as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter. For example, additional sensors such as light sensors, vibration sensors, accelerometers, current sensors, or voltage sensors may be provided to help detect failed components, diagnose failure types, and confirm operational status of vehicle accessories, components, or subsystems. Additionally, sensors external to the vehicle may be employed to provide or supplement any of the sensor or user data described hereinabove, and processors external to the vehicle may be employed to provide or supplement any of the control process steps described hereinabove. Alternatively, machine learning processes or other artificial intelligence (AI) systems may be used to estimate variables from sparse, noisy, or entwined data streams without departing from the spirit of the present disclosure. The principles described above can be equally applied to electric vehicles, internal combustion vehicles, hybrid vehicles, manual vehicles, autonomous and driver-assist vehicles, consumer vehicles, commercial vehicles, and mixed-use vehicles.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A vehicle comprising an automotive trailer lighting diagnostic system, the system comprising:
a trailer;
one or more trailer lights disposed on the trailer;
one or more components of the vehicle or trailer that are associated with the one or more trailer lights;
a user interface; and
a control unit configured to:
activate the one or more trailer lights in a particular sequence;
receive a signal identifying at least one malfunctioning trailer light of the one or more trailer lights;
automatically identify a diagnostic procedure for the at least one malfunctioning trailer light from a plurality of diagnostic procedures and initiate the identified diagnostic procedure;
execute the steps of the diagnostic procedure by:
soliciting information from a user via the user interface,
issuing instructions to the user via the user interface,
executing branching logic steps, and
initiate repair or replacement of the at least one malfunctioning trailer light through user actions via the user interface; and
recommend service options to the user if the diagnostic procedure is unable to return the at least one malfunctioning trailer light to working order.

2. The vehicle of claim 1, wherein soliciting information from the user or issuing instructions to the user involves a voice interface.

3. The vehicle of claim 1, wherein soliciting information from the user or issuing instructions to the user involves a visual interface.

4. The vehicle of claim 1, wherein soliciting information from the user or issuing instructions to the user involves a dashboard head unit.

5. The vehicle of claim 1, wherein soliciting information from the user or issuing instructions to the user involves a portable device.

6. The vehicle of claim 5, wherein the portable device comprises an augmented reality device and the instructions to the user comprise augmented reality instructions.

7. The vehicle of claim 1, wherein the at least one malfunctioning trailer light comprises a brake light.

8. The vehicle of claim 1, wherein the at least one malfunctioning trailer light comprises a turn signal indicator light.

9. The vehicle of claim 1, wherein the at least one malfunctioning trailer light comprises a tail light.

10. The vehicle of claim 1, wherein the at least one malfunctioning trailer light comprises a backup light.

11. The vehicle of claim 1, wherein the instructions to the user comprise activating controls within the automotive trailer lighting diagnostic system.

12. The vehicle of claim 1, wherein the instructions to the user comprise physical examination of the one or more components of the vehicle or trailer that are associated with the one or more trailer lights.

13. The vehicle of claim 1, wherein the instructions to the user comprise physical replacement of the one or more components of the vehicle or trailer that are associated with the one or more trailer lights.

14. A method for returning malfunctioning automotive trailer lamps to working condition, the method comprising:
activating one or more trailer lamps in a sequence;
receiving a status of at least one malfunctioning trailer lamp of the one or more trailer lamps by receiving a signal from a user via a user interface;
identifying a diagnostic procedure stored in a memory from a plurality of diagnostic procedures stored in the memory;
executing branching logic steps of the identified diagnostic procedure from the memory for the at least one malfunctioning trailer lamp;
soliciting information from the user about the at least one malfunctioning trailer lamp;
issuing instructions to the user regarding the at least one malfunctioning trailer lamp; and
if, at an endpoint of the diagnostic procedure, the at least one malfunctioning trailer lamp continues to malfunction, recommending service options to the user.

15. The method of claim 14, wherein soliciting information from or issuing instructions to the user involves a voice interface.

16. The method of claim 14, wherein soliciting information from the user or issuing instructions to the user involves a visual interface.

17. The method of claim 14, wherein soliciting information from the user or issuing instructions to the user involves a dashboard head unit or portable device.

18. The method of claim 17 wherein the portable device comprises an augmented reality device.

19. The method of claim 14, wherein the at least one malfunctioning trailer lamp comprises a brake lamp, a turn signal lamp, a tail lamp, or a backup lamp.

20. A vehicle trailer lighting diagnostic module comprising:
a user interface; and
a processor configured to:
activate one or more trailer lights of a vehicle in a particular sequence;
receive a signal indicative of a status of one or more malfunctioning trailer lights of the one or more trailer lights;
automatically identify a diagnostic procedure for the one or more malfunctioning trailer lights from a plurality of diagnostic procedures and initiate the identified diagnostic procedure;
execute branched logic paths of the identified diagnostic procedure;
solicit information from a user regarding the one or more malfunctioning trailer lights;
issue instructions to the user regarding the one or more malfunctioning trailer lights; and
recommend service options to the user if an endpoint of the identified diagnostic procedure indicates a continued malfunction status of at least one of the one or more malfunctioning trailer lights.
